(19) United States
(12) Patent Application Publication
(10) Pub. No.: US 2021/0007209 A1
(43) Pub. Date: Jan. 7, 2021

(54) ELECTROSTATIC CHARGE ELIMINATOR FOR PEOPLE

(71) Applicant: GUSTAVO FERNÁNDEZ DEL CASTILLO Y SIMÓN, Ciudad de México (MX)

(72) Inventor: GUSTAVO FERNÁNDEZ DEL CASTILLO Y SIMÓN, Ciudad de México (MX)

(21) Appl. No.: 16/982,539

(22) PCT Filed: Sep. 26, 2019
(86) PCT No.: PCT/MX2019/000012

§ 371 Date: Sep. 19, 2020

(30) Foreign Application Priority Data
Mar. 21, 2018 (MX) MX/A/2018/003473

(51) Int. Cl. H05F 3/04; G08B 5/36

(52) U.S. Cl. CPC H05F 3/04; G08B 5/36

(57) ABSTRACT

The invention relates to a suppressor device that neutralises the build-up of electrostatic charges in persons walking through places where the materials used to build them acquire an electrostatic charge, either due to their clothing or the type of flooring and footwear, generating electrostatic charges that build up to the point that a sudden discharge causes a spark that can be dangerous, especially in explosive atmospheres, harmful for electronic equipment and unpleasant for the person that feels them. The electrostatic charge suppressor uses a moderated electric discharge circuit and does so in a controlled time, while also switching on an LED or gas lamp (1) as a discharge indicator. The electrostatic charge suppressor is mounted on an insulating substrate (2) and is secured to a piece of furniture or a wall by adhesive or by a self-tapping screw, on a surface that has a certain level of conductivity to earth, placed at a point that it easily accessible for individuals walking through an area that is likely to generate an electrostatic charge in the persons walking through the place, who can touch the electrostatic discharge device as they pass through the place in order to get rid of the static electricity they built up.

### CROSS REFERENCE TO RELATED APPLICATIONS

This application claims the priority of PCT application number PCT/2019/0000129 filed Sep. 26, 2019, which in turn claims the priority of Mexico application MX/a/2018/003473 filed Mar. 21, 2018.

### STATEMENT REGARDING FEDERALLY SPONSORED RESEARCH OR DEVELOPMENT

Not applicable.

### FIELD OF INVENTION

The present invention is related to measures for safety, human comfort and the need to avoid or elude the generation of electrostatic charges manifested either by the discharge with sparks, shocks, or unpleasant sensation when opening the door of a car, greeting by hand contact to a person, or other related circumstances.

### BACKGROUND OF THE INVENTION

Electrostatic charges are of high risk in areas where explosive or flammable materials are handled, as an electrostatic discharge in a person holding a dangerous, heavy or fragile object can trigger a reaction or cause loss of balance or control if the person is in a critical position.

Stories abound where a spark was able to initiate a conflagration in hydrocarbon saturated environments, where there have been flammable liquids, gases or powders. It is quite common for somebody to store a certain level of static charge, either by friction, proximity to charged bodies or by phenomena which accumulate differentiated charges respect to the ground.

Most of the time the electrostatic charges are of low potential, therefore they are barely perceptible, so depending on the following conditions: humidity, temperature, activity performed in the enclosure or by the material with which the objects are made, will manifest an electrostatic discharge, however, these discharges become potentially harmful in sensitive electronic circuits so they surprisingly stop operating.

The inconvenience is in the face of discharges perceived by a person charged when touching or approaching to “the ground”. An electrostatic charge tends to discharge in the vicinity of the opposite pole, even more so, when the discharge is high voltage it produces a spark of greater power, distance and range by proportionally increasing its voltage.

Electrostatic charges occur in diverse environments such as: a body of high dielectric coefficient insulating material that is rubbed against another body also insulating from which it exchanges ions (charged particles are positive or negative).

Whether sitting, walk on insulating carpet or floor, rolling fabrics, paper, polymers with high dielectric coefficient, high potential charges are created that must be neutralized to prevent them disturbing or generating a risky condition by a discharge.

### Most Commonly Used Methods to Prevent and Eliminate Electrostatic Charges:

Use of tapes, brushes or conductive filaments that divert accumulated electrostatic charges, avoid or reduce its potential, to ground.

To avoid or reduce the potential of electrostatic charges, atomized water is used in the environments that acts as a neutralizer to reduce the polarization of the air when saturating it with moisture.

Another method is to continuously alternate electrical polarity of the environment by means of high voltage of alternate current electrodes to neutralize ions whether positive or negative.

The use of carbon-based coatings, metal powders or conductive materials or charges that lower the dielectric coefficient of the area and the surface of objects, and reduces electrostatic accumulation.

In some cases, it is recommended to neutralize the electrostatic charge by holding some metallic object that when touching the ground pole causes the discharge, so that the current is distributed by the skin of the hand holding the metallic object, which makes it less noticeable to the discharge, however when it is an electric shock of high potential, its undesirable effects cannot be avoided.

When handling highly sensitive high impedance electronic circuits, CMOS type with high sensitivity characteristics that are required to be protected, it is common to tie a person's body, as a shackle, to an electrical conductor end that will manipulate sensitive material and connect the other end of the conductor to a ground point.

In the state of the art, related documents such as document US20070890549P on a type of footwear exist to avoid loading static; US2015070811 which is a device to control the discharge formed by two plates of insulating elements; the document ES20110000385U useful for computer equipment; the document AR2012P100814 to unload static for vehicles entering a service station and the document ES20010000593U which does the same for cars, as well as some related ones.

The methods referred to in the preceding paragraphs are preventive, different from the electrostatic eliminator in people motive of this description.

### SUMMARY OF THE INVENTION

The discharger referred to in this invention does not prevent and avoid electrostatic charges, it eliminates them without displeasure or protruding when someone already charged touches the properly installed discharger.

In any enclosure, the accumulation of electrostatic charges makes it necessary to eliminate them in a simple, safe, pleasant and reliable way, either as a result of walking on a carpet, wooden floor, vinyl or any insulating material that by friction will act as a source of electrostatic charges that, when accumulated, acquire a high voltage, and is potentially prone to discharge in the vicinity of the opposite pole.

The electrostatic eliminator according to the present invention aims to allow all people who are in places capable of generating electrostatic charges to resort to the electrostatic eliminator, touch it and thus discharge the static electricity accumulated in the body.

The lamp of the electrostatic eliminator of the present invention serves as a discharge indicator, and includes an LED or gas lamp that allows the user to see the magnitude of the discharge and to make sure that it has been discharged.

The electrostatic eliminator referred to in this description is a visible object, available at the hand of anyone who chooses to touch it as a discharge point when that person feels they may have a static charge.

The electrostatic eliminator referred to this invention has as a main goal to discharge static electricity softy, over a longer time interval, not as a short interval as sometimes happens during an abrupt discharge that is able to produce a spark and cause an unpleasant experience to the one who experienced it.

### BRIEF DESCRIPTION OF THE DRAWINGS

FIG. 1 is a front perspective view from above of an electrostatic eliminator according to the present invention, having an insulating substrate, an LED or gas lamp discharge indicator, a discharge electrode, a conductive cable between the two above elements, and eyelets, and a ground pole.

FIG. 2 shows a bottom front perspective view of the device of FIG. 1, in which an inner face of the electrostatic eliminator is self-adhesive and also serves as an electro-conductive ground electrode; this view also showing an LED or gas lamp, a shock discharge attenuator resistance ranging from the electrode to ground to the LED or gas lamp; and having a conductive bridge that is available that is optionally cut when the conductivity of the medium where the device is to be fixed is low.

FIG. 3 is a schematic diagram of an electronic circuit of the electrostatic charge eliminator of the present invention of FIGS. 1 and 2, with a representation of the LED or gas lamp, the ground electrode, the attenuator resistance and the discharge electrode of the electrostatic charge eliminator.

### DETAILED DESCRIPTION OF THE INVENTION

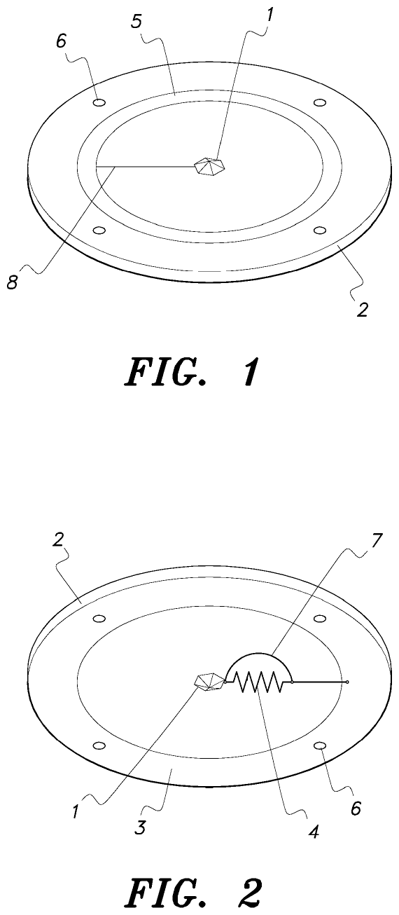

FIG. 1 is a front perspective view from above of an electrostatic eliminator according to the present invention, having an insulating substrate 2, an LED or gas lamp discharge indicator 1, a discharge electrode 5, a conductive cable 8 between the two above elements, and eyelets 6, and a ground pole or ground electrode 3 (shown in FIG. 2).

FIG. 2 shows a bottom front perspective view of the device of FIG. 1, in which an inner face of the electrostatic eliminator is self-adhesive and also serves as an electro-conductive ground electrode 3; this view also showing an LED or gas lamp 1, a shock discharge attenuator resistance 4 ranging from the electrode to ground 3 to the LED or gas lamp 1; and having a conductive bridge 7 that is available that is optionally cut when the conductivity of the medium where the device is to be fixed is low. The fixing eyelets 6 are also observed to connect or anchor to the ground pole 3.

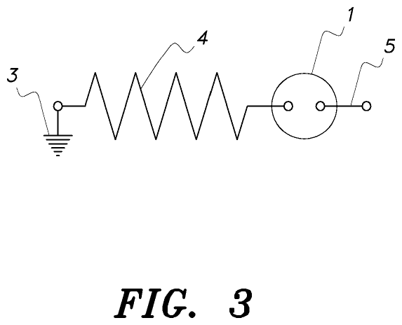

FIG. 3 is a schematic diagram of an electronic circuit of the electrostatic charge eliminator of the present invention of FIGS. 1 and 2, with a representation of the LED or gas lamp, the ground electrode, the attenuator resistance and the discharge electrode of the electrostatic charge eliminator.

To prevent unpleasant electrostatic discharges bothering any part of the human body, it is necessary to provide a means that mitigates the passage of electric current to a point referred to ground as the use of an electric resistance, that limits the electric current of the discharge, making it imperceptible to the person who touches it, avoiding the discomfort and spark risks causing explosion or damage to sensitive devices.

The electrostatic charges eliminator of the present invention is constituted and assembled to have a substrate of electrical insulating material (2) with two faces, FIG. 1 represents the external face where the visible elements necessary to activate the electrostatic charges eliminator are observed, FIG. 2 represents the hidden and inner face of the electrostatic charges eliminator, and FIG. 3 represents the electronic circuit of the electrostatic charges eliminator.

### WAY TO CARRY OUT THE INVENTION

The electrostatic charges eliminator of the present invention is assembled into a substrate of insulating material (2) of flat preference with electronic components inside mounted between both surfaces (outside and inside) so that it is appreciated that the active face is visible where the discharge electrode 5 is fixed, wherein on that side the discharge electrode 5 is preferably concentric and shaped as a circle, and having a discharge indicator a LED or gas lamp 1 connected to the discharge electrode 5 by a conductive cable 8 and by means of a resistance 4 to the electrode ground pole 3 and to a conductive bridge 7 that serves to adapt the ground impedance of the inner face.

On the inside of the electrostatic eliminator is the peripheral electrode that is connected to the ground 3 and by means of a resistance 4 to the LED or gas lamp 1 serving as a discharge indicator; the ground pole is understood as any connection point that can be exploited from a minimum electrical resistance or a high conductivity, to that which represents a lower conductivity with a higher resistance, capable of activating the LED or gas indicator lamp 1.

The ground peripheral electrode 3 comprises a self-adhesive conductive film that enables it to be glued to any surface with polarity to ground or alternatively can be fixed to that surface by use of a rivet, staple, nail or screw passing through the eyelets 6.

### Way to Operate

The electrostatic discharger is installed at scattered points in an enclosure at the level of fingertips, with an easy-to-distinguish finish and strategically distributed to be traceable by a person during a tour: before pressing the elevator calling button, touching a handle, electronic equipment that could be damaged or greeted by hand to an individual.

The electrostatic charge eliminator allows two discharge levels, selectable by means of a bridge that omits the action of resistance when staying connected; if the present invention is installed in places with low conductivity, such as a wall, the bridge 7 is maintained so as not to add the electrical resistance 4, and if it is installed in a place with low resistance, such as a metal surface, the bridge 7 is broken to adapt the discharger and operate the resistance 4 towards the electrode to the ground 3.

Over time, electrostatic charging tends to accumulate in periods determined by environmental conditions and the type of materials and finishes in construction and decoration. Persons wishing to discharge from the electrostatic charges that may have accumulated in their body must touch the discharge electrode 5, so that the current will flow from it, through the conductor 8, to the lamp 1 which will be turned on to indicate the discharge, and then from it, by the resistance 4 or the bridge 7, towards the electrode to ground 3, eliminating the annoying feeling in people and avoiding accidents or decompressions in buildings or electronic equipment.

### ELEMENTS OF THE INVENTION

1. LED or gas lamp, discharge indicator.
2. Insulating substrate.
3. Ground electrode, self-adhesive and electro-conductor.
4. Electrical resistance, shock attenuator ranging from lamp 1 to ground electrode 3.
5. Discharge electrode.
6. Fixing eyelets, to place the remover on the surface by means of staples, nails or screws.
7. Driver bridge, which is optionally cut.
8. Conductive cable, between the discharge electrode 5 and the lamp 1.

The invention being thus described, it will be evident that the same may be varied in many ways by a routineer in the applicable arts. Such variations are not to be regarded as a departure from the spirit and scope of the invention and all such modifications are intended to be included within the scope of the claims.

1: (canceled)

2: (canceled)

3. An electrostatic charges eliminator for people, comprising:
an electro insulated substrate having a first side and a second side;
a discharge electrode attached to said first side of said substrate, said discharge electrode being adapted to be touched by people to discharge static electricity;
a lamp attached to said first side of said substrate, said lamp being spaced apart from said discharge electrode;
a conductive cable connecting said discharge electrode and said lamp;
a ground electrode attached to said second side of said substrate, said ground electrode being adapted to be mounted to a ground member so as to discharge static electricity to said ground member;
an electrical resistance member attached to said second side of said substrate; and
said electrical resistance member connecting said ground electrode to said lamp;

4. An electrostatic charges eliminator according to claim 1, further comprising a manually removable conductive bridge connecting said ground electrode to said lamp, wherein two discharge levels are selectable by one of (a) leaving said manually removable conductive bridge in place to bypass said electrical resistance member, and (b) manually removing said manually removable conductive bridge leaving said electrical resistance member to discharge electricity when said substrate is installed in places with low impedance.

5. An electrostatic charges eliminator according to claim 1, wherein said substrate has a plurality of holes therethrough adapted to receive fasteners therethrough for mounting of said substrate to a support surface.

6. An electrostatic charges eliminator according to claim 1, wherein said ground electrode is a self adhesive conductive film, said film being adapted to adhere to said substrate and to a support surface for mounting said substrate to said support surface.
